(19) United States
(12) Patent Application Publication
(10) Pub. No.: US 2026/0133597 A1
(43) Pub. Date: May 14, 2026

(54) FAST-SETTLING SUPPLY WITH PREDICTIVE IN-RUSH CURRENT FOR DRIVER

(71) Applicant: Cirrus Logic International Semiconductor Ltd., Edinburgh (GB)

(72) Inventors: Rithika ARZA, Austin, TX (US); Rahul SINGH, Austin, TX (US); Zhaohui HE, Austin, TX (US)

(73) Assignee: Cirrus Logic International Semiconductor Ltd., Edinburgh (GB)

(21) Appl. No.: 19/370,137

(22) Filed: Oct. 27, 2025

Related U.S. Application Data
(60) Provisional application No. 63/718,905, filed on Nov. 11, 2024.

(30) Foreign Application Priority Data
Nov. 25, 2024 (GB) 2417232.2

(51) Int. Cl. G05F 1/46; G05F 1/56; G05F 1/573; G05F 3/26

(52) U.S. Cl. CPC G05F 1/462; G05F 1/562; G05F 1/5735; G05F 3/262

(57) ABSTRACT

A system may include an output driver configured to drive an output voltage, a voltage supply configured to generate a supply voltage for powering the output driver, and a predictive load current circuit configured to predict a load current to be drawn by the output driver and generate a supplemental in-rush current that supplements a current generated by the voltage supply in order to generate the load current.

### RELATED APPLICATIONS

The present disclosure claims priority to U.S. Provisional Patent Application Ser. No. 63/718905, filed Nov. 11, 2024, and United Kingdom Patent Application No. 2417232.2, filed Nov. 25, 2024, each of which is incorporated by reference herein in its entirety.

### FIELD OF DISCLOSURE

The present disclosure relates in general to driver circuits, including without limitation those used in personal audio devices such as wireless telephones and media players, and more specifically, to enabling a fast-settling supply voltage for the driver by using a predictive in-rush current to supplement current provided by the supply.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones or one or more speakers or otherwise driving signals through an audio system. Such circuitry often includes a power amplifier for driving an audio output signal to headphones, speakers, or other processing circuitry, and the power amplifier may often be the primary consumer of power in a personal audio device, and thus, may have the greatest effect on the battery life of the personal audio device.

An amplifier driver may often be implemented as a differential driver for driving a differential signal. Often, each differential output of the amplifier may be driven using a complementary metal-oxide-semiconductor (CMOS) driver. To enable a constant driver output impedance during rising and falling phases of the driver output, a driver is often sequentially toggled through output driver branches resulting in large shoot-through current. The duty cycle of the shoot-through current may be directly proportional to the rise/fall time supported by the driver. Consequently, the supply for the driver, which may be implemented using a low dropout (LDO) regulator, is required to support these large dynamic load steps with wide duty cycle variation and settle in accordance with signal integrity requirements (e.g., with an eye mask specification requirement).

In existing approaches, such problem was solved by adding a current-mirror based fast path to a traditional n-type metal-oxide-semiconductor (NMOS) pass device LDO regulator and a large coupling capacitor on the output to improve the settling performance at the expense of larger power and area. In such approach, the loading capacitor accounted for approximately 50% of the total LDO regulator area. Further, even with such a large load capacitor, overshoot remained high.

### SUMMARY

In accordance with the teachings of the present disclosure, certain disadvantages and problems associated with performance of supplies for drivers have been reduced or eliminated.

In accordance with embodiments of the present disclosure, a system may include an output driver configured to drive an output voltage, a voltage supply configured to generate a supply voltage for powering the output driver, and a predictive load current circuit configured to predict a load current to be drawn by the output driver and generate a supplemental in-rush current that supplements a current generated by the voltage supply in order to generate the load current.

In accordance with these and other embodiments of the present disclosure, a method may include, in a system having an output driver configured to drive an output voltage and a voltage supply configured to generate a supply voltage for powering the output driver, predicting a load current to be drawn by the output driver, and generating a supplemental in-rush current that supplements a current generated by the voltage supply in order to generate the load current.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the example, present embodiments and certain advantages thereof may be acquired by referring to the following description taken in conjunction with the accompanying drawings, in which like reference numbers indicate like features, and wherein:

FIG. 1 is a circuit diagram of selected components of an example driver system, in accordance with embodiments of the present disclosure; and

FIG. 2 is a circuit diagram of an example low dropout regulator, in accordance with embodiments of the present disclosure.

### DETAILED DESCRIPTION

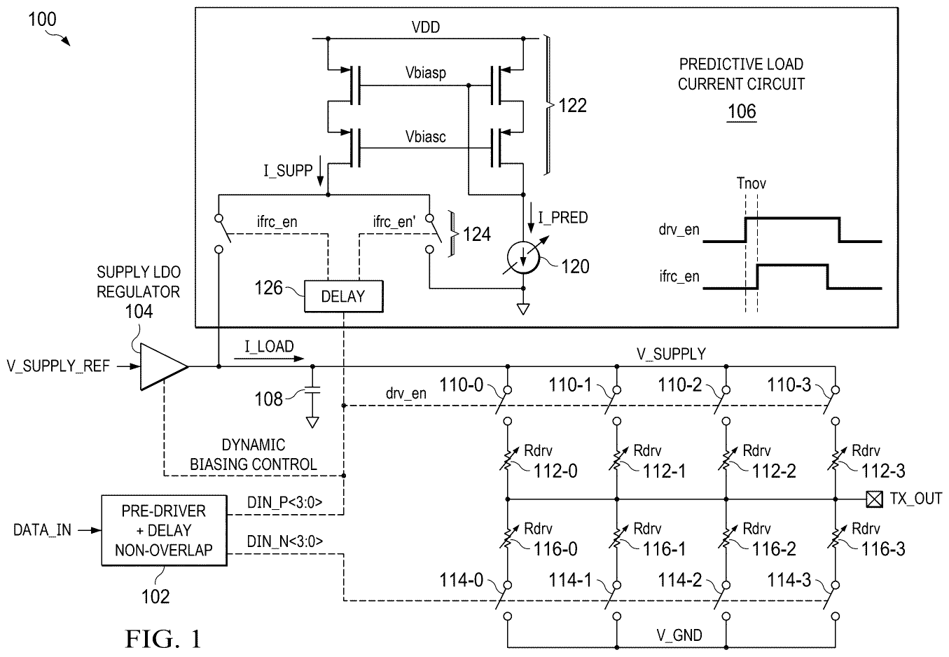

FIG. 1 is a circuit diagram of selected components of an example driver system 100, in accordance with embodiments of the present disclosure. As shown in FIG. 1, driver system 100 may include a pre-driver 102, supply LDO regulator 104, a predictive load current circuit 106, a load capacitor 108, and an output driver comprising a plurality of branches, wherein each branch may include a pull-up device depicted as an ideal switch 110 (e.g., switches 110-0, 110-1, 110-2, and 110-3) in series with a variable resistor 112 (e.g., resistors 112-0, 112-1, 112-2, 112-3) and a pull-down device depicted as an ideal switch 114 (e.g., switches 114-0, 114-1, 114-2, and 114-3) in series with a variable resistor 116 (e.g., resistors 116-0, 116-1, 116-2, 116-3). Although depicted as an ideal switch 110 in series with a variable resistor 112, a pull-up device may actually be implemented as a p-type metal-oxide-semiconductor (PMOS) transistor. Similarly, although depicted as an ideal switch 114 in series with a variable resistor 116, a pull-up device may actually be implemented as an n-type metal-oxide-semiconductor (NMOS) transistor. Although, for the purposes of clarity and exposition, FIG. 1 depicts the output driver having four branches, the output driver may have any suitable number of branches.

Pre-driver 102 may include any system, device, or apparatus configured to receive an input signal DATA_IN and based thereon, generate a plurality of control signals DIN_P<3:0> for controlling pull-up devices of the output driver and a plurality of control signals DIN_N<3:0> for controlling pull-down devices of the output driver. In some embodiments, pre-driver 102 may also include delay non-overlap circuitry configured to delay a phase of control signals DIN_P<3:0> and control signals DIN_N<3:0> with respect to input signal DATA_IN. As shown in FIG. 1, control signals DIN_P<3:0> may be generalized as a drive enable signal drv_en. As also depicted in FIG. 1, pre-driver 102 may also generate one or more signals for dynamic biasing control of supply LDO regulator 104.

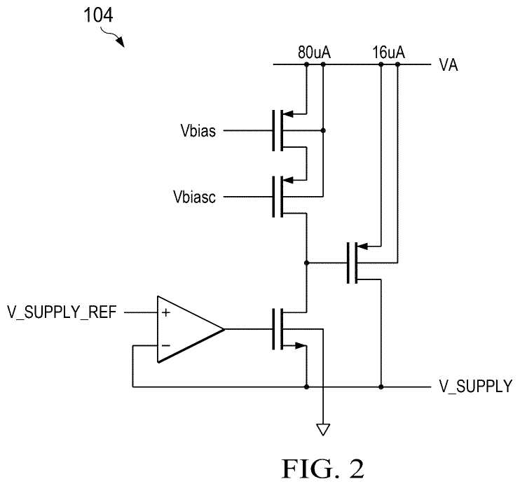

Supply LDO regulator 104 may include any system, device, or apparatus configured to receive a reference voltage V_SUPPLY_REF and based thereon, generate a regulated supply voltage V_SUPPLY for powering the output driver. In some embodiments, supply LDO regulator 104 may be implemented as a super-source follower. For example, FIG. 2 is a circuit diagram of an example supply LDO regulator 104 implemented as super-source follower, in accordance with embodiments of the present disclosure.

Predictive load current circuit 106 may include any system, device, or apparatus configured to predict a load current I_LOAD to be drawn by the output driver and generate a supplemental in-rush current I_SUPP approximately equal to the predicted load current that supplements a current driven by supply LDO regulator 104 to generate the actual load current I_LOAD onto the electrical node of regulated supply voltage V_SUPPLY. As shown in FIG. 1, a predicted load current I_PRED may be represented by an independent current source 120. Predicted load current I_PRED may be calculated based on an impedance of the output driver (including impedance at the output of the output driver) and desired voltage ramping thresholds for output voltage TX_OUT driven by the output driver. In addition or alternatively, predicted load current I_PRED may be calculated based on input signal DATA_IN. A current mirror 122 may generate supplemental in-rush current I_SUPP to be approximately equal to predicted load current I_PRED, and a current steering circuit 124 may steer supplemental in-rush current I_SUPP between the electrical node of regulated supply voltage V_SUPPLY and ground based on a control signal ifrc_en, which may be a delayed version of the drive enable signals drv_en, generated by a delay element 126. Accordingly, the amount of supplemental in-rush current I_SUPP may be calibrated to render the settling behavior of supply LDO regulator 104 invariant of process and topology.

The output driver may comprise any system, device, or apparatus configured to generate an output signal TX_OUT, which is a function of input signal DATA_IN, to another circuit. For example, in some embodiments, such other circuit may include a receiver, a loadspeaker, a headphone, or any other suitable circuit. As another example, the output driver may drive one or more output logic pins (e.g., representative of logical input/output signals) and such other circuit may comprise a processor or other digital device.

Because supplemental in-rush current I_SUPP generated by predictive load current circuit 106 may provide most of load current I_LOAD during transition of the output driver, the current flowing through supply LDO regulator 104 may be limited and hence may help optimize both area and power of the supply LDO regulator 104. Implementing supply LDO regulator 104 with a super-source follower output stage may enable a fast-settling loop within supply LDO regulator 104. Further, the power consumption and area of supply LDO regulator 104 may be considerably smaller than LDO regulators used in existing approaches (e.g., LDO regulator power consumption may be 50% smaller and LDO regulator area may be 40% smaller). In addition, the size of a loading capacitor (e.g., load capacitor 108) may be approximately 10 times smaller than that used in existing approaches.

The systems and methods described herein may provide numerous advantages over existing approaches. For example, the systems and methods described herein enable calibration of supplemental in-rush current I_SUPP based on selected voltage thresholds during rising and falling edges of output voltage TX_OUT. Further, because the output impedance of the output driver may be trimmed across process variations, the supplemental in-rush current I_SUPP may be process invariant.

Also, because supplemental in-rush current I_SUPP may provide most of the transient current for load current I_LOAD, supply LDO regulator 104 may only need to provide a smaller amount of current as compared to existing approaches. For example, if supplemental in-rush current I_SUPP provides 90% of load current I_LOAD, then supply LDO regulator 104 may need to provide only 10% of load current transient, which may lower the size requirement of load capacitor 108 compared to existing approaches and may lower a quiescent power consumed by supply LDO regulator 104 with an improved settling response as compared to existing approaches.

Further, predictive load current circuit 106 may run on a lower power supply (e.g., voltage VDD depicted in FIG. 1) to minimize overall dynamic power consumption for system 100.

Moreover, because control for predictive load current circuit 106 is provided directly from the output driver, settling behavior of supply LDO regulator 104 may be independent of the rise and fall times of output voltage TX_OUT and the data rate of input signal DATA_IN and output voltage TX_OUT.

In addition, predictive load current circuit 106 may be small comparable to other components of system 100, and thus may be added as an additional feature to supply LDO regulator 104 to boost performance of supply LDO regulator 104 at a low cost in terms of area.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
an output driver configured to drive an output voltage;
a voltage supply configured to generate a supply voltage for powering the output driver; and
a predictive load current circuit configured to:
predict a load current to be drawn by the output driver; and
generate a supplemental in-rush current that supplements a current generated by the voltage supply in order to generate the load current.

2. The system of claim 1, wherein the voltage supply is a voltage regulator.

3. The system of claim 1, wherein the predictive load current circuit is further configured to predict the load current based on desired voltage ramping thresholds for the output voltage.

4. The system of claim 1, wherein the predictive load current circuit is further configured to predict the load current based on an impedance associated with the output driver.

5. The system of claim 1, wherein:
the system further comprises an input for receiving an input signal and the output voltage is a function of the input signal; and
the predictive load current circuit is further configured to predict the load current based on the input signal.

6. The system of claim 1, wherein the output driver is configured to drive one or more output logic pins.

7. A method comprising, in a system having an output driver configured to drive an output voltage and a voltage supply configured to generate a supply voltage for powering the output driver:
predicting a load current to be drawn by the output driver; and
generating a supplemental in-rush current that supplements a current generated by the voltage supply in order to generate the load current.

8. The method of claim 7, wherein the voltage supply is a voltage regulator.

9. The method of claim 7, further comprising predicting the load current based on desired voltage ramping thresholds for the output voltage.

10. The method of claim 7, further comprising predicting the load current based on an impedance associated with the output driver.

11. The method of claim 7, wherein:
the system further comprises an input for receiving an input signal and the output voltage is a function of the input signal; and
the method further comprises predicting the load current based on the input signal.

12. The method of claim 7, wherein the output driver is configured to drive one or more output logic pins.
